(19) United States
(12) Patent Application Publication
(10) Pub. No.: US 2020/0077678 A1
(43) Pub. Date: Mar. 12, 2020

(54) Nutritionally Premium Cola Carbonated Soft Drink - Composition, Method of Preparation and Applications

(71) Applicant: A. Reza Kamarei, Princeton, NJ (US)

(72) Inventor: A. Reza Kamarei, Princeton, NJ (US)

(21) Appl. No.: 16/544,239

(22) Filed: Aug. 19, 2019

Related U.S. Application Data
(60) Provisional application No. 62/765,731, filed on Sep. 11, 2018.

(51) Int. Cl. A23L 2/38; A23L 2/66; A23L 2/58; A23L 33/105; A23L 33/125; A23L 33/15; A23L 33/20; A23L 33/00; A23L 2/68; A23L 2/60; A23L 2/56

(52) U.S. Cl. CPC A23L 2/38; A23L 2/66; A23L 2/58; A23L 33/105; A23L 33/125; A23L 2/56; A23L 33/20; A23L 33/30; A23L 2/68; A23L 2/60; A23L 33/15

(57) ABSTRACT

Disclosed are the use of nutritive and health promoting vitamin C (ascorbic acid) in formulation, preparation and applications of Nutritionally Premium Cola (NPC) carbonated soft drinks. Also disclosed are exemplary compositions, methods of preparation and applications of NPC carbonated soft drinks.

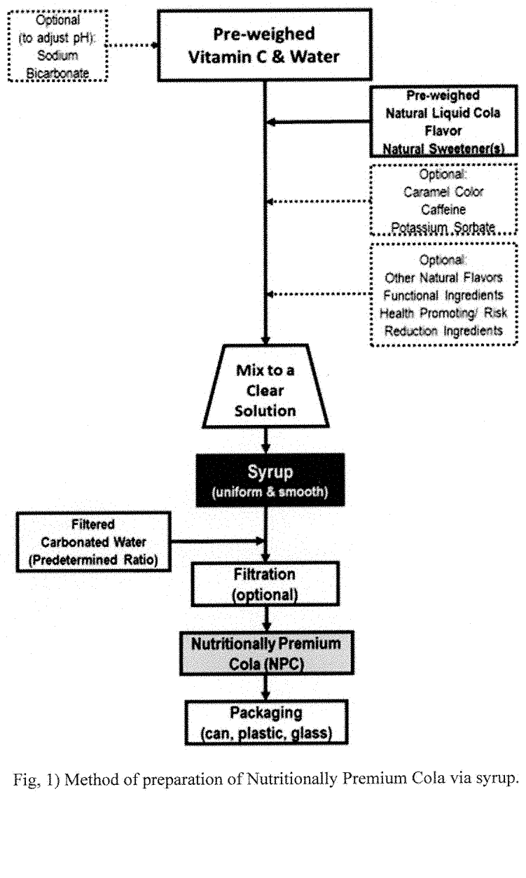

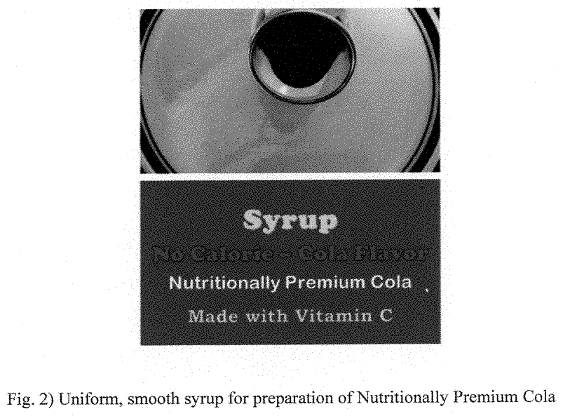

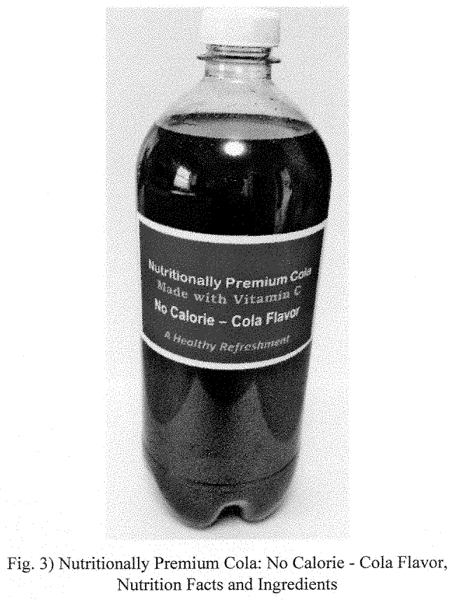

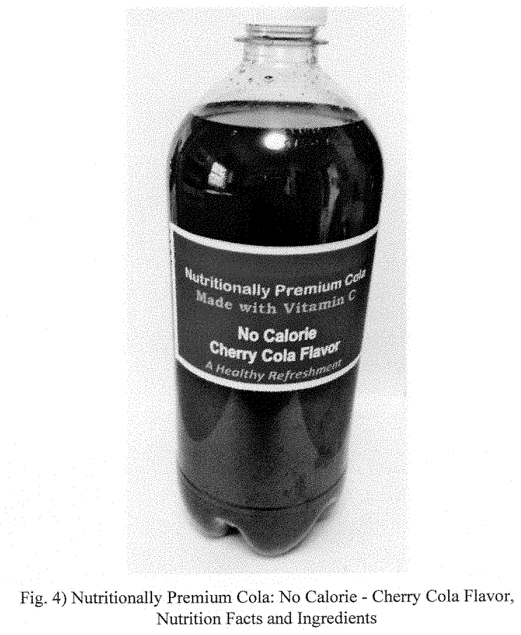

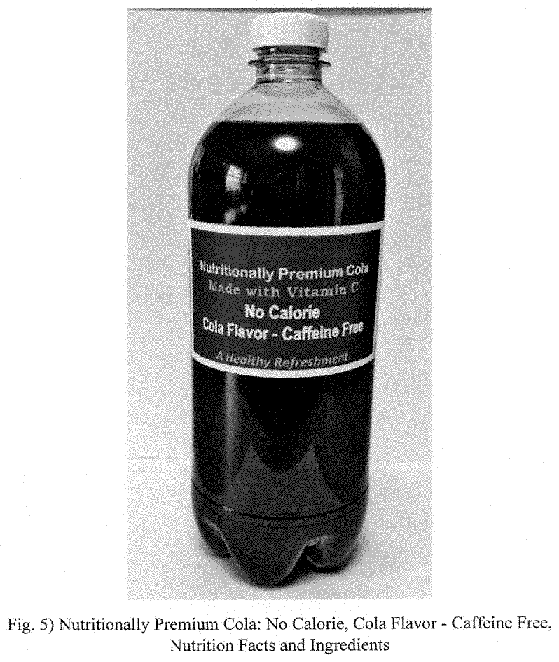

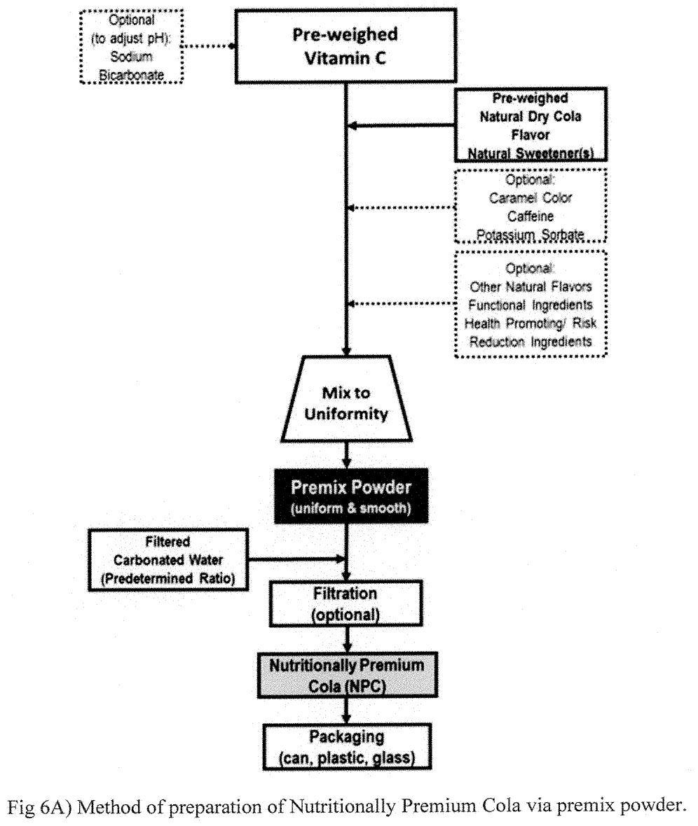

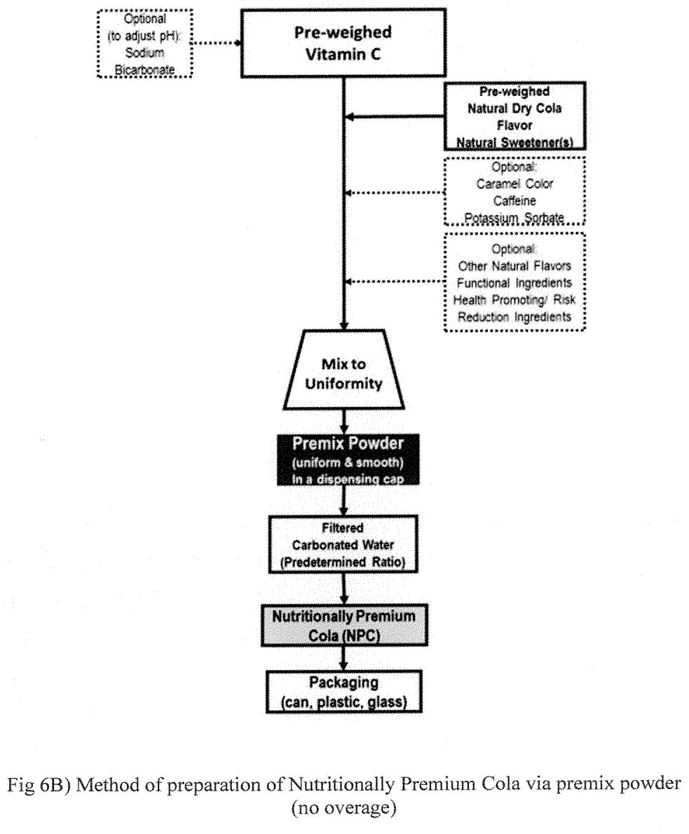

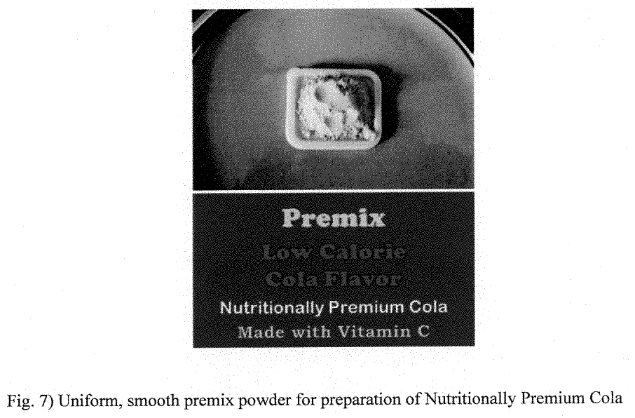

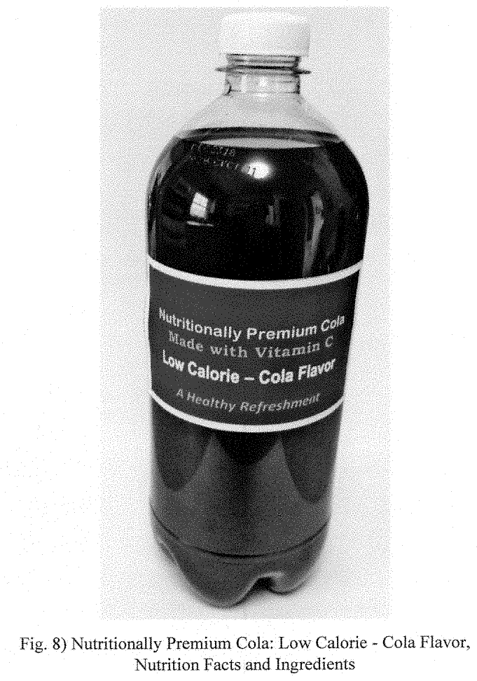

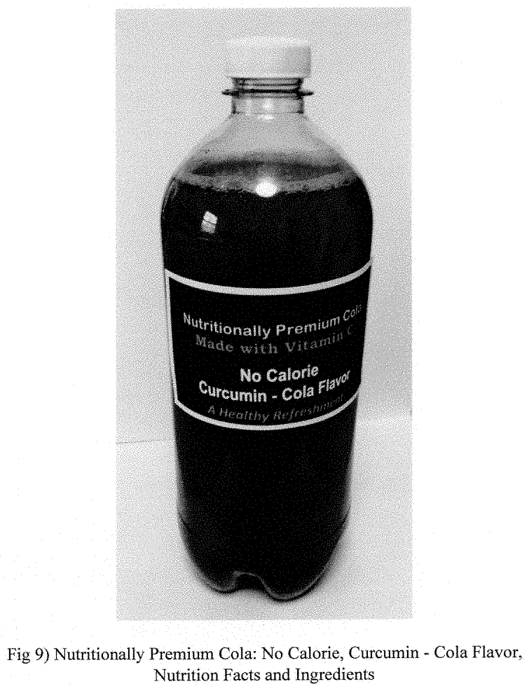

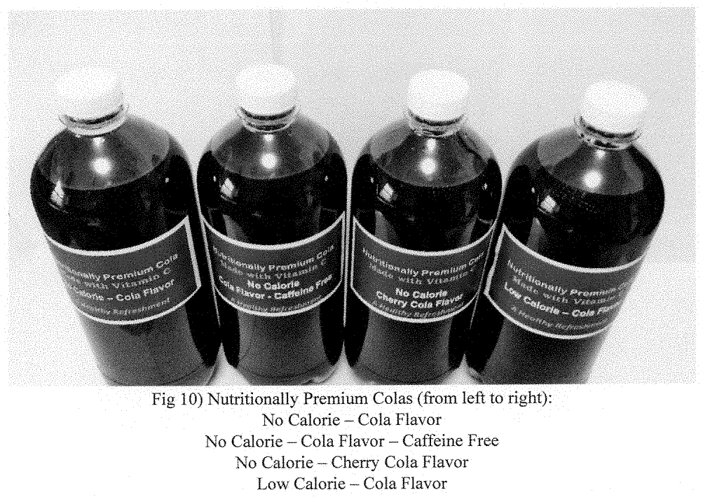

### BACKGROUND OF THE INVENTION

### 1. Field of the Invention

The present invention pertains to composition, method of preparation and applications of Nutritionally Premium Cola (NPC) Carbonated Soft Drink.

### 2. Description of Prior Art

### (A) Soft Drink Industry:

According to the Grand Review Research (Carbonated Soft Drinks Market Size, Share & Trends Analysis Report, 2018-2025), the global carbonated soft drinks market size was worth USD 392.6 billion in 2016. North America accounted for the major revenue share of 30.3% in 2016.

According to the Statista, in 2015, some 40.7 gallons of soft drinks were consumed per capita, down from 45.5 gallons per capita in 2010 (i.e., 10.5% reduction in consumption in 5 years).

Growing concern regarding obesity in the U.S. and Mexico coupled with taxes imposed by the government on sugar-based products is likely to restraint the growth of carbonated soft drinks in the region. Consumers in the region have been shifting towards non-carbonated beverages on account of high health consciousness.

“Breaking Down the Chain: A Guide to the Soft Drink Industry” is a report that was published by Public Health & Law Policy (a nonprofit organization that provides legal information on matters relating to public health) in 2011. According to this report, the soft drink industry is made up of two major manufacturing systems that, taken together, bring soft drinks to the market:
Flavoring Syrup and Concentrate Manufacturing
Soft Drink Manufacturing

The supply chain is largely dependent on the syrup producer, as this is the driver for most downstream operations. The majority of the bottled soft drinks follow a similar product life cycle, moving from syrup producer, to bottler, to distributor (if used), to merchant, to final consumer. Changes in consumers' consumption due to increased health consciousness is one of the industry's main challenges.

The final products of soft drink production are distributed through six main channels:

1) supermarkets and general merchandisers, 2) food service and drinking places, 3) convenience stores and gas stations, 4) vending machine operations, 5) smaller outlets (drug stores, community centers, private clubs) and 6) exports.

Soft drinks can be divided into six main segments: 1) carbonated soft drinks, 2) fruit beverages, 3) bottled waters, 4) functional beverages, 5) sport drinks and 6) others.

### (B) Carbonated Soft Drinks (CSD) or Sparkling Drinks:

Carbonated soft drinks or sparkling drinks are those soft drinks that are carbonated. During carbonation process, carbon dioxide (CO₂) gas under pressure is dissolved in the soft drink. Carbonation causes the drink to become effervescent. Carbonation increases in a solution as temperature decreases. The simplest CSD is carbonated (sparkling) water.

Carbonated soft drink segment is broken down into two subsegments:
Colas
Noncolas.

### (C) Colas

Cola is a sweetened carbonated soft drink flavored with cola flavor. It also usually contains caramel color, caffeine and preservatives. The cola flavor is the signature flavor among carbonated soft drinks and is enormously popular. The present invention is related to the cola subsegment of carbonated soft drinks segment.

Ingredients of commercially available cola carbonated soft drinks are shown below (35 colas from the two leading companies Coca-Cola and Pepsi (including SodaStream) and 34 colas from the third-position leader Dr Pepper Snapple Group (including RC Cola and Diet Rite) as well as Hansen's Natural, Blue Sky, Zevia, Whole Foods, Fentimans, Faygo, Double Cola, Jarriots, Jolt Cola, Jones Soda and Sam's.

| COMPANY | BRAND | INGREDIENTS |
|---|---|---|
| Coca-Cola | Coca-Cola - | Carbonated Water, High Fructose Corn Syrup, Caramel Color, Phosphoric |
| | Original | Acid, Natural Flavors, Caffeine |
| | Caffeine Free | Carbonated Water, High Fructose Corn Syrup, Caramel Color, Phosphoric |
| | Coca Cola | Acid, Natural Flavors |
| | Caffeine Free Diet | Carbonated Water, Caramel Color, Aspartame, Phosphoric Acid, Potassium |
| | Coke | Benzoate, Natural Flavors, Citric Acid |
| | Coca-Cola Life | Carbonated Water, Cane Sugar, Caramel Color, Natural Flavors, Phosphoric |
| | | Acid, Potassium Benzoate, Caffeine, Stevia Leaf Extract |
| | Coca-Cola Zero | Carbonated Water, Caramel Color, Phosphoric Acid, Aspartame, Potassium |
| | Sugar | Benzoate, Natural Flavors, Potassium Citrate, Acesulfame Potassium, Caffeine |
| | Coca-Cola Cherry | Carbonated Water, Caramel Color, Phosphoric Acid, Aspartame, Potassium |
| | Zero | Benzoate, Natural Flavors, Acesulfame Potassium, Potassium Citrate, Caffeine |
| | Diet Coke - | Carbonated Water, Caramel Color, Aspartame, Phosphoric Acid, Potassium |
| | Original | Benzoate, Natural Flavors, Citric Acid, Caffeine |
| | Diet Coke - Zesty | Carbonated Water, Less Than 0.5% Of: Natural Flavors, Caramel Color, |
| | Blood Orange | Phosphoric Acid, Aspartame, Acesulfame Potassium, Potassium Benzoate, |
| | | Potassium Citrate, Caffeine |
| | Diet Coke - Feisty | Carbonated Water, Caramel Color, Phosphoric Acid, Potassium Benzoate, |
| | Cherry | Aspartame, Natural Flavors, Acesulfame Potassium, Caffeine |
| | Diet Coke - | Carbonated Water, Less Than 0.5% Of: Natural Flavors, Caramel Color, |
| | Twisted Mango | Phosphoric Acid, Aspartame, Acesulfame Potassium, Potassium Benzoate, |
| | | Potassium Citrate, Caffeine |
| | Diet Coke - Ginger | Carbonated Water, Less Than 0.5% Of: Natural Flavors, Caramel Color, |
| | Lime | Phosphoric Acid, Aspartame, Acesulfame Potassium, Potassium Benzoate, |
| | | Potassium Citrate, Caffeine |
| | TaB | Carbonated Water, Caramel Color, Natural Flavors, Phosphoric Acid, Calcium |
| | | Saccharin, Potassium Benzoate, Caffeine, Aspartame |
| | Pibb Xtra | Carbonated Water, High Fructose Corn Syrup, Caramel Color, Phosphoric |
| | | Acid, Potassium Sorbate, Potassium Benzoate, Artificial and Natural Flavors, |
| | | Caffeine, Monosodium Phosphate, Lactic Acid, Polyethylene Glycol |
| | Pibb Zero | Carbonated Water, Caramel Color, Phosphoric Acid, Aspartame, Potassium |
| | | Sorbate and Potassium Benzoate, Artificial and Natural Flavors, Acesulfame |
| | | Potassium, Caffeine, Monosodium Phosphate, Lactic Acid, Polyethylene |
| | | Glycol |
| Pepsi | Pepsi | Carbonated Water, High Fructose Corn Syrup, Caramel |
| | | Color, Sugar, Phosphoric Acid, Caffeine, Citric Acid, Natural Flavor |
| | Caffeine Free | Carbonated Water, High Fructose Corn Syrup, Caramel |
| | Pepsi | Color, Sugar, Phosphoric Acid, Citric Acid, Natural Flavor |
| | Crystal Pepsi | Carbonated Water, High Fructose Corn Syrup, Phosphoric Acid, Citric |
| | | Acid, Sodium Benzoate, Sodium Citrate, Caffeine, Gum Arabic, Natural |
| | | Flavor |
| | Pepsi Cherry | Carbonated Water, High Fructose Corn Syrup, Caramel Color, Natural |
| | Vanilla | Flavor, Phosphoric Acid, Potassium Sorbate, Potassium Citrate, Citric |
| | | Acid, Caffeine, Potassium Benzoate, Calcium Disodium EDTA |
| | Pepsi Real Sugar | Carbonated Water, Sugar, Caramel Color, Phosphoric Acid, Caffeine, Natural |
| | | Flavor |
| | Pepsi Limon | Carbonated Water, Sugar, Lime Juice Concentrate, Caramel Color, Sodium |
| | | Potassium Hexametaphosphate, Natural Flavor, Citric Acid, Tartaric |
| | | Acid, Potassium Citrate, Caffeine, Phosphoric Acid, Potassium |
| | | Sorbate, Calcium Disodium EDTA |
| | Pepsi True | Carbonated Water, Sugar, Caramel Color, Phosphoric Acid, Natural |
| | | Flavor, Caffeine, Purified Stevia Leaf Extract |
| | Pepsi Wild Cherry | Carbonated Water, High Fructose Corn Syrup, Caramel |
| | | Color, Sugar, Phosphoric Acid, Natural Flavor, Caffeine, Citric Acid |
| | Pepsi Zero Sugar | Carbonated Water, Caramel Color, Phosphoric Acid, Aspartame, Potassium |
| | | Benzoate, Caffeine, Natural Flavor, Acesulfame Potassium, Citric |
| | | Acid, Calcium Disodium EDTA, Panax Ginseng Root Extract |
| | Pepsi Wild Cherry | Carbonated Water, Caramel Color, Phosphoric Acid, Natural |
| | Zero Sugar | Flavor, Aspartame, Caffeine, Potassium Sorbate, Potassium |
| | | Citrate, Acesulfame Potassium, Citric Acid |
| | Diet Pepsi | Carbonated Water, Caramel Color, Aspartame, Phosphoric Acid, Potassium |
| | | Benzoate, Caffeine, Citric Acid, Natural Flavor, Acesulfame Potassium |
| | Diet Pepsi with | Carbonated Water, Caramel Color, Phosphoric Acid, Potassium |
| | Splenda | Benzoate, Sucralose, Acesulfame Potassium, Caffeine, Natural Flavor, Citric |
| | | Acid |
| | Caffeine Free Diet | Carbonated Water, Caramel Color, Aspartame, Phosphoric Acid, Potassium |
| | Pepsi | Benzoate, Citric Acid, Natural Flavor, Acesulfame Potassium |
| | Diet Pepsi Lime | Carbonated Water, Caramel Color, Natural Flavor, Phosphoric |
| | | Acid, Aspartame, Citric Acid, Potassium Citrate, Caffeine, Potassium |
| | | Sorbate, Acesulfame Potassium |
| | Diet Pepsi Vanilla | Carbonated Water, Caramel Color, Natural And Artificial Flavor, Phosphoric |
| | | Acid, Aspartame, Potassium Citrate, Caffeine, Potassium Sorbate, Acesulfame |
| | | Potassium, Citric Acid, Calcium Disodium EDTA |
| | Diet Pepsi Wild | Carbonated Water, Caramel Color, Phosphoric Acid, Natural |
| | Cherry | Flavor, Aspartame, Potassium Benzoate, Potassium Citrate, Citric |
| | | Acid, Caffeine, Acesulfame Potassium, Calcium Disodium EDTA |
| SodaStream | Cola - Original | Sugar, Water, Caramel Coloring, Phosphoric Acid, Natural Flavor, |
| Mix | Formula | Acesulfame Potassium, Tri Sodium Citrate, Caffeine, Sucralos |
| | Diet Cola - | Water, Caramel Coloring, Phosphoric Acid, Natural Flavor, Citric Acid, |
| | Original Formula | Acesulfame Potassium, Caffeine, Surcralose, Tirsodium Citrate |
| | Diet Caffeine Free | Water, Caramel Coloring, Natural & Artificial Flavors, Citric Acid, Sucralose, |
| | Cola | Acesulfame Potassium, Phosphoric Acid, Acacia Gum, Sodium Benzoate |
| | Cherry Cola | Sugar, Water, Caramel Coloring, Natural Flavor, Phosphoric Acid, Citric |
| | | Acid, Acesulfame Potassium, Sucralose, Caffeine, Sodium Benzoate |
| | Diet Dr Pete | Water, Artificial Flavor, Caramel Coloring, Phosphoric Acid, Sucralose, |
| | | Caffeine, Sodium Benzoate |

| COMPANY | BRAND | INGREDIENTS |
|---|---|---|
| Dr Pepper | Dr Pepper | Carbonated Water, High Fructose Corn Syrup, Caramel Color, Phosphoric |
| Snapple | | Acid, Natural and Artificial Flavors, Sodium Benzoate, Caffeine |
| | Der Pepper Cherry | Carbonated Water, High Fructose Corn Syrup, Caramel Color, Natural and |
| | | Artificial Flavors, Sodium Benzoate, Citric Acid, Phosphoric Acid, Caffeine, |
| | | Malic Acid, Sodium Phosphate, Red 40 |
| | Diet Dr Pepper | Carbonated Water, Caramel Color, Aspartame, Phosphoric Acid, Natural and |
| | | Artificial Flavors, Sodium Benzoate, Caffeine |
| | Dr Pepper TEN | Carbonated Water, High Fructose Corn Syrup, Caramel Color, Phosphoric |
| | | Acid, Aspartame, Sodium Benzoate, Caffeine, Natural and Artificial Flavors, |
| | | Acesulfame Potassium, Sodium Phosphate |
| | Diet Dr Pepper | Carbonated Water, Caramel Color, Natural and Artificial Flavors, Aspartame, |
| | Cherry | Sodium Benzoate, Citric Acid, Phosphoric Acid, Caffeine, Malic Acid, |
| | | Sodium Phosphate, Red 40 |
| | Caffeine Free Dr | Carbonated Water, High Fructose Corn Syrup, Caramel Color, Phosphoric |
| | Pepper | Acid, Natural and Artificial Flavors, Sodium Benzoate |
| | Dr Pepper Cherry | Carbonated Water, High Fructose Corn Syrup, Caramel Color, Natural and |
| | Vanilla | Artificial Flavors, Sodium Benzoate, Citric Acid, Phosphoric Acid, Caffeine, |
| | | Malic Acid, Red 40 |
| | Diet Cherry | Carbonated Water, Caramel Color, Natural and Artificial Flavors, Aspartame, |
| | Vanilla Dr Pepper | Sodium Benzoate, Citric Acid, Phosphoric Acid, Caffeine, Malic Acid, Red |
| | | 40 |
| | Caffeine Free Diet | Carbonated Water, Caramel Color, Aspartame, Phosphoric Acid, Natural and |
| | Dr Pepper | Artificial Flavors, Sodium Benzoate |
| | Dr Pepper Made | Carbonated Water, Cane Sugar, Caramel Color, Phosphoric Acid, Natural |
| | W/ Cane Sugar | and Artificial Flavors, Sodium Benzoate, Caffeine |
| RC Cola | RC Cola | Carbonated Water, High Fructose Corn Syrup, Caramel Color, Phosphoric |
| | | Acid, Caffeine, Natural Flavors, Acacia Gum |
| | RC Cola Diet | Carbonated Water, Caramel Color, Phosphoric Acid, Potassium Citrate, |
| | | Sucralose, Citric Acid, Acacia Gum, Potassium Benzoate, Caffeine, Natural |
| | | Flavors |
| | RC Cola Cherry | Carbonated Water, High Fructose Corn Syrup, Caramel Color, Phosphoric |
| | | Acid, Caffeine, Natural Flavors, Acacia Gum |
| Diet Rite | Diet Rite Cola | Carbonated Water, Caramel Color, Phosphoric Acid, Sucralose, Citric Acid, |
| | | Potassium Benzoate, Acesulfame Potassium, Natural Flavors, Acacia Gum, |
| | | Potassium Citrate |
| | Diet Rite Cola | Carbonated Water, Caramel Color, Phosphoric Acid, Potassium Benzoate, |
| | Cherry | Sucralose, Citric Acid, Natural and Artificial Flavors, Acesulfame Potassium, |
| | | Acacia Gum, Potassium Citrate |
| Hansen's | Original Cola | Carbonated Water, Cane Sugar, Natural Caramel Color, Citric Acid, Tartaric |
| Natural | | Acid, Natural Flavors with Extracts of Kola Nuts |
| | Diet Cola | Carbonated Water, Caramel Color, Phosphoric Acid, Natural Flavors |
| | | (Nutmeg Spice, Sweet Cinnamon, Orange Oil), Acesulfame Potassium, |
| | | Sucralose |
| Blue Sky | Natural Soda Cola | Filtered Carbonated Water, Sugar, Caramel Color (from Sugar), Tartaric |
| | | Acid, Natural Cola Nut Flavor, Citric Acid |
| | Cane Sugar Soda | Filtered Carbonated Water, Invert Cane Sugar, Caramel Color Tartaric Acid, |
| | Cola | Natural Cola Nut Flavor, Citric Acid |
| | Natural Soda Cola - | Triple Filtered Carbonated Water, Erythritol, Natural Flavors (African Ivory |
| | Zero Calorie | Coast Kola Nut, South American Kola Nut Oil), Caramel Color, Tartaric |
| | | Acid, Rebiana (Stevia Extract) |
| Whole | 365 Cola | Filtered Carbonated Water, Cane Sugar, Caramel Color (from Cane Sugar), |
| Foods | | Tartaric Acid, Natural Cola Nut Flavor, Citric Acid |
| Fentimans | Fentimans | Water, Carbonated Water, Sugar, Cola Flavour, Ginger, Natural Herbal |
| | Curiosity Cola | Extract, Colour Caramel, Phosphoric Acid, Caffeine |
| Zevia | Cola | Carbonated Water, Stevia Leaf Extract, Tartaric Acid, Natural Flavors, |
| Zero | | Caffeine, Citric Acid |
| Calorie | | |
| | Caffeine Free Cola | Carbonated Water, Stevia Leaf Extract, Tartaric Acid, Natural Flavors, Citric |
| | | Acid |
| | Cherry Cola | Carbonated Water, Stevia Leaf Extract, Tartaric Acid, Natural Flavors, Citric |
| | | Acid, Caffeine |
| Fentimans | Fentimans | Water, Carbonated Water, Sugar, Cola Flavour, Ginger, Natural Herbal |
| | Curiosity Cola | Extract, Colour Caramel, Phosphoric Acid, Caffeine |
| Faygo | Faygo Cola | Carbonated Water, High Fructose Corn Syrup, Caramel Color, Phosphoric & |
| | | Citric Acid, Natural Flavor, Caffeine |
| | Faygo Diet Cola | Carbonated Water, Caramel Color, Phosphoric Acid, Aspartame, Potassium |
| | | Benzoate, Citric Acid, Natural Flavor, Caffeine. |
| Double | Double Cola | Carbonated Water, High Fructose Corn Syrup, Caramel Color, Phosphoric |
| Cola | | Acid, Caffeine, Natural and Artificial Flavor, Gum Arabic |
| | Diet Double Cola | Carbonated Water, Caramel Color, Phosphoric Acid, Potassium Citrate, |
| | | Aspartame, Potassium Benzoate, Citric Acid, Acesulfame Potassium, Natural |
| | | and Artificial Flavor |
| Jarritos | Jarritos Mexican | Carbonated Water (Water, Carbon Dioxide), Natural Sugar, Artificial and |
| | Cola | Natural Flavors, Caramel Color, Phosphoric Acid, Sodium Benzoate, |
| | | Caffeine |
| Jolt Cola | Jolt Cola | Carbonated Water, Sugar, Caramel Color, Phosphoric Acid, Caffeine, Citric |
| | | Acid, Natural Flavor |
| Jones | Jones Cane Sugar | Carbonated Water, Inverted Cane Sugar, Natural Flavors, Caramel Color, |
| Soda | Soda | Phosphoric Acid, Sodium Benzoate and Potassium Sorbate, Caffeine, |
| | | Calcium Disodium EDTA, Gum Acacia, Xanthan Gum |
| Sam's | Sam's Cola | Carbonated Water, High Fructose Corn Syrup, Caramel Color, Phosphoric |
| | | Acid, Natural Flavor, Caffeine |
| | Diet Sam's Cola | Carbonated Water, Caramel Color, Phosphoric Acid, Aspartame, Potassium |
| | | Citrate, Potassium Benzoate, Natural Flavor, Caffeine |

As mentioned above, cola flavor (including acidic flavoring agent) and sweetener are the required ingredients for production of colas. Other ingredients such as color, caffeine and preservatives are added, as needed, as complementary and auxiliary ingredients.

(a) Cola Flavor: the original flavoring ingredient in a cola drink was sourced from the kola nut, the caffeine-containing fruit of the kola tree, leading to the drink's name (“cola”). The modern flavoring ingredients in a cola drink are citrus oils (from oranges, limes or lemon fruit peel), cinnamon, vanilla, and an acidic flavoring agent. The base flavorings that most people identify with a cola taste remain citrus, vanilla and cinnamon. Manufacturers of cola drinks add trace flavorings (spices like nutmeg, coriander, etc.) to create distinctively different tastes for each brand. Acidity is predominantly provided by inorganic phosphoric acid, mostly accompanied by organic citric acid, and other organic acids such as tartaric acid, malic acid and even lactic acid.
(b) Sweetener: the sweetness comes from calorific natural sweeteners (e.g., sugar and high-fructose corn syrup), no-calorie, artificial high-intensity sweeteners (e.g., saccharin, aspartame, acesulfame potassium, and sucralose) and no-calorie, natural high-intensity sweeteners (e.g., stevia leaf extract and monk fruit extract).
(c) Color: most colas contain caramel color which gives the cola its dark brown or black color; although clear colas have also been introduced to market.
(d) Caffeine: A stimulant of central nervous system. It is found in the seeds, nuts, or leaves of a number of plants native to Africa, East Asia and South America. Beverages containing caffeine are ingested to relieve or prevent drowsiness and to improve performance. However, it can produce a mild form of caffeine addiction (associated with withdrawal symptoms such as sleepiness, headache, and irritability) when an individual stop using caffeine after repeated daily intake.
(e) Preservative: A substance or a chemical that is added to prevent decomposition by microbial growth or by undesirable chemical changes. Common preservatives in colas include benzoic acid, sodium benzoate, potassium benzoate, calcium benzoate, potassium sorbate, and erythorbic acid (also known as isoascorbic acid which is chemically a different compound from ascorbic acid).

### (D) Health Risks

Consumers increasingly realizes the role of foods and beverages in their health, and therefore increasingly demand healthier and more nutritious food and beverages. The reality is that all sugary and almost all diet colas in the marketplace are considered unhealthy and have a negative image to consumers.

Hintz (1980) in his article “calcium, cola, calamity” has reviewed some of the criticisms about soft drink industry and provides comments on the adverse effects of soft drink consumption on nutritional status. This researcher believes that soft drinks contain no nutrients other than sugar, whereas milk contains many nutrients. Thus, the substitution of soft drinks for milk results in great decreases of minerals, protein, and vitamins but calcium is a nutrient of particular concern because milk is the major source of calcium. Calcium inadequacy may be involved in the development of osteoporosis and periodontal disease. As far as acids in soft drinks (below pH 3.0) is concerned, Hintz refers to decry on ingestion of soft drinks by many patients, but especially those receiving antacid therapy for peptic ulcers. He also mentions earlier reports on erosion of teeth to be caused by cola drinks [Hintz, HF, calcium, cola, calamity, The Cornell Veterinarian, 1980, 70(1) 3-9].

Kristensen et al (2005) conducted a 10-day intervention study in young men on short-term effect of replacing milk with cola beverages on bone turnover. These investigators demonstrated that over a 10-day period high intake of cola with a low-calcium diet induces increased bone turnover compared to a high intake of milk with a low-calcium diet. Thus, the trend towards a replacement of milk with cola and other soft drinks, which results in a low calcium intake, may negatively affect bone health as indicated by this short-term study [Kristensen et al, Osteoporosis Int, 2005, 16 (12):1803-8].

In a review titled “Hard Facts About Soft Drinks” (Feb. 14, 2014), Mullen from academy of nutrition and dietetics expresses: “They provide essentially no key nutrients”.

Carbonated soft drinks are referred to as non-nutritive beverages. Sugar and Phosphoric Acid are considered to be the main risks in cola carbonated soft drinks:

### (a) Sugar Risk to Health

According to Center for Disease Control and Prevention (CDC), “Sugar-sweetened beverages (SSBs) or sugary drinks are leading sources of added sugars in the American diet. Frequently drinking sugar-sweetened beverages is associated with weight gain/obesity, type 2 diabetes, heart disease, kidney diseases, non-alcoholic liver disease, tooth decay and cavities, and gout, a type of arthritis. Limiting the amount of SSB intake can help individuals maintain a healthy weight and have a healthy diet.” Considering position of US federal government and concern of consumers across the board, it is not surprising that “increasing competition from “soda alternatives” and a growing antipathy toward sugar have led to 13 straight years of volume decline for carbonated soft drinks (Beverage-Digest Soda Trends Report, 2^{nd} Edition, January 2018).

In response to “sugar concern”, leaders of carbonated soft drink industry initially came up with the diet versions of carbonated soft drinks using no-calorie artificial high-intensity sweeteners (e.g., saccharin, aspartame, acesulfame potassium and sucralose). When consumers showed reluctance toward “artificial sweeteners” despite their regulatory approval, industry leaders responded by using no-calorie “natural” high-intensity sweeteners (e.g., stevia leaf extract and monk fruit extract). This has been considered a reasonable response by the consumers. Industry has also been developing reduced sugar version of regular carbonated soft drinks. This is also welcomed by the consumers.

### (b) Phosphoric Acid Risks to Health

Ingredients of commercially available cola carbonated soft drinks in terms of acids used in colas are as follows: Phosphoric acid is found in 62 out of 69 colas (89.8%) as follows:
Phosphoric acid is found in 29 colas.
Phosphoric acid together with citric acid is found in 26 colas.
Phosphoric acid together with citric acid, and tartaric or malic acid is found in 5 colas.
Phosphoric acid together with tartaric or malic or lactic acid is found in 2 colas.

Phosphoric acid, H₃PO₄ (also known as orthophosphoric acid) is a solid, non-toxic inorganic acid. The most common form of phosphoric acid is colorless, odorless 85% syrupy aqueous solution. Food-grade 85% phosphoric acid has a pH level below 1, meaning it should be distributed by licensed professionals, and all that interact with the chemical should wear proper safety attire and equipment. At moderate concentrations phosphoric acid solutions are irritating to the skin. Contact with concentrated solutions can cause severe skin burns and permanent eye damage.

The dominant use of phosphoric acid is for fertilizers, consuming approximately 90% of production. However, it is also used in soaps and detergents, food industry, water treatment and tooth pastes. Some specific applications of phosphoric acid include anti-rust treatment by phosphate conversion coating, phosphoric acid fuel cells, activated carbon production, and sanitizing agent in the dairy, food, and brewing industries.

To produce food-grade phosphoric acid, phosphate ore is first reduced with coke (fuel) in an electric arc furnace, to make elemental phosphorus. Elemental phosphorus is distilled out of the furnace and burned with air to produce high-purity phosphorus pentoxide (anhydride of phosphoric acid) which is dissolved in water to make phosphoric acid. The resultant phosphoric acid may be further purified by removing compounds of arsenic and other potentially toxic impurities.

American Beverage Association defines phosphoric acid as follows: “This flavoring agent in soft drinks is a preservative that provides tartness.” It is known in industry that in colas, phosphoric acid is used as a flavor enhancer, providing a tangy or sour taste. In United States, phosphoric acid is GRAS (Generally Recognized As Safe) food substance when used in accordance with good manufacturing practice. In European Union, phosphoric acid is permitted food additive (E338) as acidity regulator and chelating agent.

In spite of its regulatory status, specific health risks regarding the use of phosphoric acid in colas have been reported in scientific literature:
Risk to Bone Health

Given the awareness and the concern about the impact of carbonated beverage consumption on children's health, Wyshak (2000) explored the possible association between carbonated beverage consumption and bone fractures among teenaged girls. A cross-sectional (retrospective) study was done on four hundred sixty 9th- and 10th-grade girls attending the high school by completing a self-administered questionnaire relating to their physical activities and personal and behavioral practices. The girls' self-reports on physical activity, carbonated beverage consumption, and bone fractures were analyzed. In the total sample, carbonated beverage consumption and bone fractures are associated. Among physically active girls, the cola beverages, in particular, are highly associated with bone fractures [Wyshak, Arch Pediatr Adolesc Med, 2000 June; 154(6):610-3].

Tucker et al (2006) noted that soft drink consumption may have adverse effects on Bone Mineral Density (BMD), but studies have shown mixed results. Colas contain caffeine and phosphoric acid which may adversely affect bone. These investigators hypothesized that consumption of cola is associated with lower BMD. They measured BMD at the spine and 3 hip sites in 1413 women and 1125 men in the Framingham Osteoporosis Study by using dual-energy X-ray absorptiometry. Dietary intake was assessed by food-frequency questionnaire. They regressed each BMD measure on the frequency of soft drink consumption for men and women after adjustment for body mass index, height, age, energy intake, physical activity score, smoking, alcohol use, total calcium intake, total vitamin D intake, caffeine from noncola sources, season of measurement, and, for women, menopausal status and estrogen use. They found that cola intake was associated with significantly lower (P<0.001-0.05) BMD at each hip site, but not the spine, in women but not in men. The mean BMD of those with daily cola intake was 3.7% lower at the femoral neck and 5.4% lower at Ward's area than of those who consumed <1 serving cola/mo. Similar results were seen for diet cola and, although weaker, for decaffeinated cola. No significant relations between noncola carbonated beverage consumption and BMD were observed. Total phosphorus intake was not significantly higher in daily cola consumers than in nonconsumers; however, the calcium-to-phosphorus ratios were lower. They concluded that intake of cola, but not of other carbonated soft drinks, is associated with low BMD in women [Tucker et al, Am J Clin Nutr. 2006 October; 84(4):936-42].

Calvo and Tucker (2013) asked if the phosphorus intake that exceeds dietary requirements is a risk factor in bone health because phosphorus intake in excess of the nutrient needs of healthy adults is thought to disrupt hormonal regulation of phosphorus, calcium, and vitamin D, contributing to impaired peak bone mass, bone resorption, and greater risk of fracture. These researchers concluded that there is accumulating evidence that phosphorus added to the food supply may be contributing to the burden of osteoporosis in the population. Further work is needed to accurately quantify the effects of exposure to differential phosphorus sources in the diet. The example of cola as a source of added phosphorus without the associated nutrients usually found in pure food dietary sources suggests that this is an important consideration for bone health and fracture prevention [Calvo and Tucker, Ann NY Acad Sci. 2013, October; 1301:29-35].
Risk to Kidney Health

Saldana et al (2007) indicated that carbonated beverage consumption has been linked with diabetes, hypertension, and kidney stones, all risk factors for chronic kidney disease. They mentioned that cola beverages, in particular, contain phosphoric acid and have been associated with urinary changes that promote kidney stones. These researchers examined the relationship between carbonated beverages (including cola) and chronic kidney disease, using data from 465 patients with newly diagnosed chronic kidney disease and 467 community controls recruited in North Carolina between 1980 and 1982. They found that drinking 2 or more colas per day was associated with increased risk of chronic kidney disease. Results were the same for regular colas and artificially sweetened colas. Noncola carbonated beverages were not associated with chronic kidney disease. They concluded that their preliminary results suggest that cola consumption may increase the risk of chronic kidney disease [Saldana et al Epidemiology 2007 July; 18(4):501-6].

Santucci et al (2010) reported a case of severe delayed methotrexate (chemotherapy agent and immune system suppressant) elimination attributable to consumption of a cola beverage. They investigated unexplained low urinary pH in a lymphoma patient treated with high-dose methotrexate and found unexpected urinary acidity, despite administration of large amounts of sodium bicarbonate, could be attributed to repeated consumption of a cola beverage which resulted in a delayed elimination of methotrexate and acute renal failure. Discontinuation of cola drinks, increase in calcium folinate rescue and in sodium bicarbonate allowed satisfactory elimination of methotrexate on day 12 after infusion and recovery from renal impairment without other severe toxicity. No other cause of delay in methotrexate elimination could be identified. These medical investigators concluded that cola beverages have a low pH due to their phosphoric acid content that is excreted by renal route. They recommended patients receiving high dose methotrexate abstain from any cola drink within 24 h before and during methotrexate administration and until complete elimination of the drug [Santucci et al Br J Clin Pharmacol 2010 November; 70(5):762-4].

Lin and Curhan (2011) explored how sugar or artificially sweetened soda may be related to kidney function decline on 3318 women participating in the Nurses' Health Study with data on soda intake and albuminuria. The results showed consumption of ≥2 servings per day of artificially sweetened (diet) soda was independently associated with estimated Glomerular Filtration Rate (eGFR) decline ≥30% and ≥3 ml/min per 1.73 m² per year. No increased risk for eGFR decline was observed for <2 servings per day of diet soda. These researchers concluded that consumption of ≥2 servings per day of artificially sweetened soda is associated with a 2-fold increased odds for kidney function decline in women.

A Clinical Practice Guideline from the American College of Physicians on Dietary and Pharmacologic Management to Prevent Recurrent Nephrolithiasis (kidney stone) in Adults (2014) clarifies that “Although some low-quality evidence shows that a decrease in the consumption of soft drinks is associated with a reduced risk for stone recurrence, this benefit was limited to patients who drank soft drinks acidified by phosphoric acid, such as colas, but not for drinks acidified by citric acid, such as fruit-flavored sodas” [Qaseem et at, Clinical Guidelines |4 Nov. 2014, Annals of Internal Medicine].
Risk to Teeth Health

Harding et al (2003) conducted a cross sectional study in 202 5-year-old Irish school children to examine dental erosion and associated factors. They found the prevalence of dental erosion overall was 47%, in 21% erosion affected the dentine or pulp. Levels in fluoridated and non-fluoridated areas were similar. Low socio-economic status and frequency of fruit squash and carbonated drink consumption were associated with erosion extending to dentine or pulp [Harding et al (Community Dent Health. 2003 September; 20(3):165-70].

Cheng et al (2009) reported a case of dental erosion and severe tooth decay related to soft drinks. The inherent acids and sugars in soft drinks have both acidogenic and cariogenic potential, resulting in dental caries and potential enamel erosion. In this report, they presented a 25-year-old man complaining with the severe worn-out of the front teeth during the past 3 years. He had a history of drinking cola for more than 7 years and had a poor oral hygiene. Severe decays were present in the incisors and the canines, while less severe lesions were noted on the premolars and the molars. Their review is to show the relationship between dental erosion and caries and soft drinks [Cheng et al J Zhejiang Univ Sci B, 2009 May 10(5):395-399].

Reddy et al (2016) defines dental erosion as chemical dissolution of tooth structure in the absence of bacteria when the environment is acidic (pH<4.0). Their research indicates that low pH is the primary determinant of a beverage's erosive potential. In addition, citrate chelation of calcium ions may contribute to erosion at higher pH. The authors purchased 379 beverages from stores and assessed their pH. They found that 93% beverages had a pH of less than 4.0, and 7% had a pH of 4.0 or more. Relative beverage erosivity zones based on studies of apatite solubility in acid indicated that 39% of the beverages tested in this study were considered extremely erosive (pH<3.0), 54% were considered erosive (pH 3.0 to 3.99), and 7% were considered minimally erosive (pH≥4.0). Comprehensive pH assessment of commercially available beverages in the United States by these researchers shows that most are potentially erosive to the dentition. These researchers believe that specific dietary recommendations for the prevention of dental erosion may now be developed based on the patient's history of beverage consumption [Reddy et al J Am Dent Assoc. 2016 April; 147(4):255-63].

### (c) Preservative Risk to Health

This risk is minor compared to sugar risk and phosphoric acid risk. Generally-speaking, consumers prefer simplicity and transparency of ingredients mentioned on the label of foods and beverages including colas. Chemical names of preservatives are not consumer friendly and, therefore, may carry a rather negative message to the consumer. The only major precaution is about using preservative benzoic acid and its salts (sodium benzoate, potassium benzoate and calcium benzoate) in presence of ascorbic acid or erythorbic acid which leads to formation of benzene. Benzene is of potential public concern due to its carcinogenic nature. The take home message is that benzoic acid and its salts must not be added to a drink that contains ascorbic acid or erythorbic acid.

### (E) Vitamin C

Vitamin C, also known as ascorbic acid and L-ascorbic acid, is an “essential” nutrient. This means that humans are unable to synthesize it internally so it must be supplied from outside (food or supplement). Vitamin C is a cofactor in at least eight enzymatic reactions in humans and important in many essential functions, including wound healing. In humans, vitamin C deficiency compromises collagen synthesis, contributing to the more severe symptoms of scurvy. Vitamin C is on the World Health Organization (WHO) list of essential medicines.

Information about vitamin C (used below) can be found from the following sources:
National Institutes of Health, Office of Dietary Supplements: https://ods.od.nih.gov/factsheetsNitaminC-HealthProfessional/
Oregon State University, Linus Pauling Institute, Micronutrient Information Center: https://lpi.oregonstate.edu/mic/vitamins/vitamin-C
Wikipedia: https://en.wikipedia.org/wiki/Vitamin_C
Healthline: https://www.healthline.com/nutrition/vitamin-c-benefits

### (a) Discovery

Vitamin C was discovered in 1912, isolated in 1928 and synthesized in 1933, making it the first vitamin to be synthesized. Shortly thereafter, Tadeus Reichstein succeeded in synthesizing the vitamin in bulk. This made possible the inexpensive mass-production of vitamin C. In 1934 Hoffman-La Roche trademarked synthetic vitamin C under the brand name Redoxon® and began to market it as a dietary supplement (the brand is now owned by German pharmaceutical company Bayer).

### (b) Industrial

Vitamin C is produced from glucose by two main routes: 1) The Reichstein process, developed in the 1930s, which uses a single pre-fermentation followed by a purely chemical route. 2) The modern two-step fermentation process, originally developed in China in the 1960s, uses additional fermentation to replace part of the later chemical stages. Both processes yield approximately 60% vitamin C from the glucose feed. Neither the Reichstein process, nor the two-stage fermentation process, involves the use of genetically modified organisms (GMOs). In biological systems, ascorbic acid can be found only at low pH, but in solutions above pH 5 is predominantly found in the ionized form, ascorbate. All of these molecules have vitamin C activity and thus are used synonymously with vitamin C. Therefore, the term vitamin C encompasses several vitaminers that have vitamin C activity. Ascorbate salts such as sodium ascorbate, potassium ascorbate, calcium ascorbate, magnesium ascorbate and zinc ascorbate are used in some dietary supplements. These compounds release ascorbate upon digestion. Ascorbate and ascorbic acid are both naturally present in the body, since the forms interconvert according to pH. Ascorbyl palmitate is an ester formed from ascorbic acid and palmitic acid creating a fat-soluble form of vitamin C. In addition to its use as a source of vitamin C, it is also used as an antioxidant food additive.

### (c) Recommended Intakes

In US, intake recommendations for vitamin C and other nutrients are provided in the Dietary Reference Intakes (DRIs) developed by the Food and Nutrition Board (FNB) at the Institute of Medicine (IOM) of the National Academies (formerly National Academy of Sciences). DRI is the general term for a set of reference values used for planning and assessing nutrient intakes of healthy people. These values, which vary by age and gender include:
Recommended Dietary Allowance (RDA): Average daily level of intake sufficient to meet the nutrient requirements of nearly all (97%-98%) healthy individuals; often used to plan nutritionally adequate diets for individuals.
Tolerable Upper Intake Level (UL): Maximum daily intake unlikely to cause adverse health effects.

The RDA for vitamin C is 90 mg/day for an adult male and 75 mg/day for an adult female. The UL for vitamin C is 2,000 mg/day for adults (male and female). This amount is 22 times of RDA for an adult male and 26 times of RDA for an adult female. Interestingly, in 2014, the Canadian Food Inspection Agency evaluated the effect of fortification of foods with ascorbate in the guidance document, Foods to Which Vitamins, Mineral Nutrients and Amino Acids May or Must be Added. Voluntary and mandatory fortification was described for various classes of foods. Among foods classified for mandatory fortification with vitamin C were fruit-flavored drinks, bases, concentrates and mixes that are used for making fruit flavored drinks, foods for a very low-energy diet, meal replacement products, ready breakfast, instant breakfast, and evaporated milk.

### (d) Absorption and Excretion

Oral vitamin C produces tissue and plasma concentrations that the body tightly controls. Approximately 70%-90% of vitamin C is absorbed at moderate intakes of 30-180 mg/day. However, at doses above 1 g/day, absorption falls to less than 50% and absorbed, unmetabolized ascorbic acid is excreted in the urine. Results from pharmacokinetic studies indicate that oral doses of 1.25 g/day ascorbic acid produce mean peak plasma vitamin C concentrations of 135 micromol/L, which are about two times higher than those produced by consuming 200-300 mg/day ascorbic acid from vitamin C-rich foods. Pharmacokinetic modeling predicts that even doses as high as 3 g ascorbic acid taken every 4 hours would produce peak plasma concentrations of only 220 micromol/L. The human body can store only a certain amount of vitamin C, and so the body stores are depleted if fresh supplies are not consumed. Vitamin C is a water-soluble vitamin, with dietary excesses not absorbed, and excesses in the blood rapidly excreted in the urine, so it exhibits remarkably low acute toxicity. Excretion, can be as ascorbic acid, via urine. In humans, during times of low dietary intake, vitamin C is reabsorbed by the kidneys rather than excreted. Only when plasma concentrations are 1.4 mg/dL or higher does re-absorption decline and the excess amounts pass freely into the urine.

### (e) Sources of Vitamin C

Fruits and vegetables are the best sources of vitamin C. Citrus fruits, tomatoes and tomato juice, and potatoes are major contributors of vitamin C to the American diet. Other good food sources include red and green peppers, kiwifruit, broccoli, strawberries, Brussels sprouts, and cantaloupe. The richest source of natural vitamin C is acerola cherry. The vitamin C content of food may be reduced by prolonged storage and by cooking because ascorbic acid is water soluble and is destroyed by heat. Supplements typically contain vitamin C in the form of ascorbic acid, which has equivalent bioavailability to that of naturally occurring ascorbic acid in foods, such as orange juice and broccoli. Vitamin C supplements include sodium ascorbate, potassium ascorbate, calcium ascorbate, magnesium ascorbate and other mineral ascorbates and combination products. Vitamin C is among the most widely taken dietary supplement and is available in a variety of forms, including tablets, drink mix packets, capsules, and as crystalline powder. Tablet and capsule content ranges from 25 mg to 1500 mg per serving. The most commonly used supplement compounds are ascorbic acid, sodium ascorbate and calcium ascorbate.

### (f) Vitamin C Deficiency

Acute vitamin C deficiency leads to scurvy. The timeline for the development of scurvy varies, depending on vitamin C body stores, but signs can appear within 1 month of little or no vitamin C intake (below 10 mg/day). Initial symptoms can include fatigue (probably the result of impaired carnitine biosynthesis), malaise, and inflammation of the gums. As vitamin C deficiency progresses, collagen synthesis becomes impaired and connective tissues become weakened, causing petechiae, ecchymoses, purpura, joint pain, poor wound healing, hyperkeratosis, and corkscrew hairs. Additional signs of scurvy include depression as well as swollen, bleeding gums and loosening or loss of teeth due to tissue and capillary fragility. Iron deficiency anemia can also occur due to increased bleeding and decreased nonheme iron absorption secondary to low vitamin C intake. In children, bone disease can be present. Left untreated, scurvy is fatal. Today, vitamin C deficiency and scurvy are rare in developed countries but can still occur in people with limited food variety.

### (g) Groups at Risk of Vitamin C Inadequacy

The following groups are more likely than others to be at risk of obtaining insufficient amounts of vitamin C: smokers and passive “smokers”, individuals with limited food variety, people with malabsorption and certain chronic diseases and infants fed evaporated or boiled milk.

### (h) Vitamin C and Health

Vitamin C is required for the biosynthesis of collagen, L-carnitine, and certain neurotransmitters; vitamin C is also involved in protein metabolism. Collagen is an essential component of connective tissue, which plays a vital role in wound healing. Vitamin C is also an important physiological antioxidant. Ongoing research is examining whether vitamin C, by limiting the damaging effects of free radicals through its antioxidant activity, might help prevent or delay the development of certain cancers, cardiovascular disease, and other diseases in which oxidative stress plays a causal role. Due to its function as an antioxidant and its role in immune function, vitamin C has been promoted as a means to help prevent and/or treat numerous health conditions. The following section focuses on four diseases and disorders in which vitamin C might play a role: cancer (including prevention and treatment), cardiovascular disease, age-related macular degeneration and cataracts, and the common cold.
Cancer prevention

Epidemiologic evidence suggests that higher consumption of fruits and vegetables is associated with lower risk of most types of cancer, perhaps, in part, due to their high vitamin C content. Vitamin C can limit the formation of carcinogens, such as nitrosamines, in vivo; modulate immune response; and, through its antioxidant function, possibly attenuate oxidative damage that can lead to cancer. Most case-control studies have found an inverse association between dietary vitamin C intake and cancers of the lung, breast, colon or rectum, stomach, oral cavity, larynx or pharynx, and esophagus. Plasma concentrations of vitamin C are also lower in people with cancer than controls. However, evidence from prospective cohort studies is inconsistent, possibly due to varying intakes of vitamin C among studies. Evidence from most randomized clinical trials suggests that vitamin C supplementation, usually in combination with other micronutrients, does not affect cancer risk. At this time, the evidence is inconsistent on whether dietary vitamin C intake affects cancer risk. Results from most clinical trials suggest that modest vitamin C supplementation alone or with other nutrients offers no benefit in the prevention of cancer. A substantial limitation in interpreting many of these studies is that investigators did not measure vitamin C concentrations before or after supplementation. Plasma and tissue concentrations of vitamin C are tightly controlled in humans. At daily intakes of 100 mg or higher, cells appear to be saturated and at intakes of at least 200 mg, plasma concentrations increase only marginally. If subjects' vitamin C levels were already close to saturation at study entry, supplementation would be expected to have made little or no difference on measured outcomes.
Cancer treatment

Studies in 1970s suggested that high-dose vitamin C has beneficial effects on quality of life and survival time in patients with terminal cancer. However, some subsequent studies did not support these findings. A 2003 review assessing the effects of vitamin C in patients with advanced cancer concluded that vitamin C confers no significant mortality benefit. Emerging research suggests that the route of vitamin C administration (intravenous vs. oral) could explain the conflicting findings. Some researchers support reassessment of the use of high-dose intravenous vitamin C as a drug to treat cancer. It is uncertain whether supplemental vitamin C and other antioxidants might interact with chemotherapy and/or radiation. Therefore, individuals undergoing these procedures should consult with their oncologist prior to taking vitamin C or other antioxidant supplements, especially in high doses.
Cardiovascular disease

Evidence from many epidemiological studies suggests that high intakes of fruits and vegetables are associated with a reduced risk of cardiovascular disease. This association might be partly attributable to the antioxidant content of these foods because oxidative damage, including oxidative modification of low-density lipoproteins, is a major cause of cardiovascular disease. Results from prospective studies examining associations between vitamin C intake and cardiovascular disease risk are conflicting. In a 16-year prospective study involving 85,118 female nurses, total intake of vitamin C from both dietary and supplemental sources was inversely associated with coronary heart disease risk. However, intake of vitamin C from diet alone showed no significant associations, suggesting that vitamin C supplement users might be at lower risk of coronary heart disease. A much smaller study indicated that postmenopausal women with diabetes who took at least 300 mg/day vitamin C supplements had increased cardiovascular disease mortality while in male physicians, use of vitamin C supplements for a mean of 5.5 years was not associated with a significant decrease in total cardiovascular disease mortality or coronary heart disease mortality. A pooled analysis of nine prospective studies that included 293,172 subjects free of coronary heart disease at baseline found that people who took ≥700 mg/day of supplemental vitamin C had a 25% lower risk of coronary heart disease incidence than those who took no supplemental vitamin C. The authors of a 2008 meta-analysis of prospective cohort studies, including 14 studies reporting on vitamin C for a median follow-up of 10 years, concluded that dietary, but not supplemental, intake of vitamin C is inversely associated with coronary heart disease risk. Results from most clinical intervention trials have failed to show a beneficial effect of vitamin C supplementation on the primary or secondary prevention of cardiovascular disease. However, as discussed in the cancer prevention section, clinical trial data for vitamin C are limited by the fact that plasma and tissue concentrations of vitamin C are tightly controlled in humans. If subjects' vitamin C levels were already close to saturation at study entry, supplementation would be expected to have made little or no difference on measured outcomes.
Age-related macular degeneration (AMD) and cataracts

AMD and cataracts are two of the leading causes of vision loss in older individuals. Oxidative stress might contribute to the etiology of both conditions. Thus, researchers have hypothesized that vitamin C and other antioxidants play a role in the development and/or treatment of these diseases. The authors of a 2007 systematic review and meta-analysis of prospective cohort studies and randomized clinical trials concluded that the current evidence does not support a role for vitamin C and other antioxidants, including antioxidant supplements, in the primary prevention of early AMD. Although research has not shown that antioxidants play a role in AMD development, some evidence suggests that they might help slow AMD progression. High dietary intakes of vitamin C and higher plasma ascorbate concentrations have been associated with a lower risk of cataract formation in some studies.
The common cold

In the 1970s, Nobel laureate Linus Pauling suggested that vitamin C could successfully treat and/or prevent the common cold. Results of subsequent controlled studies have been inconsistent, resulting in confusion and controversy, although public interest in the subject remains high. Overall, the evidence to date suggests that regular intakes of vitamin C at doses of at least 200 mg/day do not reduce the incidence of the common cold in the general population, but such intakes might be helpful in people exposed to extreme physical exercise or cold environments and those with marginal vitamin C status, such as the elderly and chronic smokers. The use of vitamin C supplements might shorten the duration of the common cold and ameliorate symptom severity in the general population, possibly due to the anti-histamine effect of high-dose vitamin C. However, taking vitamin C after the onset of cold symptoms does not appear to be beneficial.

(i) Health Risks from Excessive Vitamin C

Vitamin C has low toxicity and is not believed to cause serious adverse effects at high intakes. The most common complaints are diarrhea, nausea, abdominal cramps, and other gastrointestinal disturbances due to the osmotic effect of unabsorbed vitamin C in the gastrointestinal tract. In postmenopausal women with diabetes who participated in the Iowa Women's Health Study, supplemental (but not dietary) vitamin C intake (at least 300 mg/day) was significantly associated with an increased risk of cardiovascular disease mortality. The mechanism for this effect, if real, is not clear and this finding is from a subgroup of patients in an epidemiological study. No such association has been observed in any other epidemiological study, so the significance of this finding is uncertain. High vitamin C intakes also have the potential to increase urinary oxalate and uric acid excretion, which could contribute to the formation of kidney stones, especially in individuals with renal disorders. However, studies evaluating the effects on urinary oxalate excretion of vitamin C intakes ranging from 30 mg to 10 g/day have had conflicting results, so it is not clear whether vitamin C actually plays a role in the development of kidney stones. The best evidence that vitamin C contributes to kidney stone formation is in patients with pre-existing hyperoxaluria. Due to the enhancement of nonheme iron absorption by vitamin C, a theoretical concern is that high vitamin C intakes might cause excess iron absorption. In healthy individuals, this does not appear to be a concern. However, in individuals with hereditary hemochromatosis, chronic consumption of high doses of vitamin C could exacerbate iron overload and result in tissue damage. Under certain conditions, vitamin C can act as a pro-oxidant, potentially contributing to oxidative damage. A few studies in vitro have suggested that by acting as a pro-oxidant, supplemental oral vitamin C could cause chromosomal and/or DNA damage and possibly contribute to the development of cancer. However, other studies have not shown increased oxidative damage or increased cancer risk with high intakes of vitamin C. Other reported effects of high intakes of vitamin C include reduced vitamin B12 and copper levels, accelerated metabolism or excretion of ascorbic acid, erosion of dental enamel, and allergic responses. However, at least some of these conclusions were a consequence of assay artifact, and additional studies have not confirmed these observations.

(j) Interactions with Medications

Vitamin C supplements have the potential to interact with several types of medications, e.g., chemotherapy and radiation and statins. Individuals taking these medications on a regular basis should discuss their vitamin C intakes with their healthcare providers.

### (k) World's Leading Scientific Entity on Vitamin C

The Linus Pauling Institute (Oregon State University) is the world leading scientific and research entity on vitamin C. Below are “Summary” and “Recommendation” on Vitamin C by Linus Pauling Institute:

### SUMMARY

“Vitamin C, also known as ascorbic acid, is a water-soluble vitamin. Unlike most mammals and other animals, humans do not have the ability to make ascorbic acid and must obtain vitamin C from the diet.
Inside our bodies, vitamin C functions as an essential cofactor in numerous enzymatic reactions, e.g., in the biosynthesis of collagen, carnitine, and catecholamines, and as a potent antioxidant.
Prospective cohort studies indicate that higher intakes of vitamin C from either diet or supplements are associated with a reduced risk of cardiovascular disease (CVD), including coronary heart disease and stroke.
Observational prospective cohort studies report no or modest inverse associations between vitamin C intake and the risk of developing a given type of cancer. Randomized controlled trials have shown no effect of vitamin C supplementation on cancer outcomes.
Prospective cohort studies indicate that higher blood levels of vitamin C are associated with lower risk of death from all-causes, cancer, and CVD.
Pharmacological doses of vitamin C administered intravenously are generally safe and well tolerated in cancer patients. The potential for intravenous ascorbic acid as an adjunct to cancer therapies is currently under investigation in phase II clinical trials.
Overall, there is evidence that regular use of vitamin C supplements shortens the duration of the common cold, but the effect in cold treatment may be limited.
Vitamin C supplements are available in many forms, but there is little scientific evidence that any one form is better absorbed or more effective than another.
There is no scientific evidence that large amounts of vitamin C (up to 10 grams/day in adults) exert any adverse or toxic effects. An upper level of 2 grams/day is recommended in order to prevent some adults from experiencing diarrhea and gastrointestinal disturbances.
Supplemental vitamin C increases urinary oxalate levels, but whether an increase in urinary oxalate elevates the risk for kidney stones is not yet known. Those predisposed for kidney stone formation may consider avoiding high-dose (1,000 mg/day) vitamin C supplementation.”

### Recommendation:

“Based on the combined evidence from metabolic, pharmacokinetic, and observational studies and from randomized controlled trials, it has been argued that sufficient scientific evidence exists to support an optimum, daily vitamin C intake of at least 200 mg/day, which is substantially higher than the current RDA. Studies conducted at the National Institutes of Health showed that plasma and circulating cells in healthy, young subjects attained near-maximal concentrations of vitamin C at a dose of 400 mg/day. Because of the very high benefit-to-risk ratio of vitamin C supplementation, and to ensure tissue and body saturation of vitamin C in almost all healthy people, the Linus Pauling Institute recommends a vitamin C intake of at least 400 mg daily for adult men and women. Consuming at least five servings (2Y2 cups) of fruit and vegetables daily provides about 200 mg of vitamin C. Most multivitamin/mineral supplements provide 60 mg of vitamin C. To make sure you meet the Institute's recommendation, supplemental vitamin C in two separate 250-mg doses taken in the morning and evening is recommended.”

The above scientific literature review confirms that phosphoric acid in colas is not only a non-nutritive ingredient but it causes risks to health of bones, kidney and teeth. Therefore, phosphoric acid in colas should logically be substituted by nondamaging and preferably by nutritive and health-promoting organic acids.

Fortunately, some companies have been active in this area: For example, Hansen's Natural (since 1935), Sky Blue (since 1971), Zevia (since 2007) and recently Whole Food 365 Cola do not use phosphoric acid in their formulations and instead use citric acid and tartaric acid. While this is a right step for the health of consumers, in reality these companies have avoided the “bad inorganic acid” and instead have used “not-bad organic acids”.

No nutritive and health promoting organic acid is used as the acid in formulation of any commercially available cola carbonated soft drink. This is the new and useful idea behind the present invention. This also indicates that the new and useful idea of the present invention, and the cola carbonated soft drinks developed based on this idea, have not been obvious to the cola carbonated soft drink companies.

The present invention is about Nutritionally Primum Cola (NPC) where the cola is fundamentally made with vitamin C as a “nutritive and health promoting” organic acid in the formulation. It is important to realize that the present invention is not a so-called vitamin-fortified soft drink. In other words, it is not about a typical regular cola (made with phosphoric acid, citric acid, tartaric acid, malic acid or lactic acid) to which vitamin C is added as a fortification method.

Interestingly, review of the patent landscape (USPTO) also shows that there is no known composition, method of preparation or applications on the subject of present invention, Nutritionally Premium Cola made with vitamin C:

| NUMBER | TITLE (US Issued Patents) |
|---|---|
| 9,173,425 | High-potency sweetener composition with vitamin and compositions sweetened therewith |
| 8,962,058 | High-potency sweetener composition with vitamin and compositions sweetened therewith |
| 8,377,491 | High-potency sweetener composition with vitamin and compositions sweetened therewith |
| 6,866,877 | Carbonated fortified milk-based beverage and method for suppressing bacterial growth in the |
| | beverage |
| 9,351,517 | Formulations of water-soluble derivatives of vitamin E and compositions containing same |
| 9,173,425 | High-potency sweetener composition with vitamin and compositions sweetened therewith |
| 8,962,058 | High-potency sweetener composition with antioxidant and compositions sweetened therewith |
| 8,377,491 | High-potency sweetener composition with vitamin and compositions sweetened therewith |
| 9,131,717 | Shelf-stable beverage composition |
| 8,568,818 | High-purity Rebaudioside D and low-calorie carbonated drink containing the same |
| 8,568,818 | High-purity Rebaudioside D and low-calorie carbonated drink containing the same |
| 8,535,747 | Beverage products having steviol glycosides and at least one acid |
| 8,535,746 | Beverage products having steviol glycosides and at least one acid |
| 8,277,862 | Beverage products having steviol glycosides and at least one acid |
| 8,153,180 | Method and apparatus for making beverages |
| 7,052,725 | Calcium-supplemented beverages and method of making same |
| 6,139,895 | Viscosity stable acidic edible liquid compositions and method of making |

| NUMBER | TITLE (US Patent Applications) |
|---|---|
| 20150190450 | Ingredient for consumption and application |
| 20140234488 | Beverage system, including bubble beverage, instant beverage, beverage with dissolved gas, |
| | and beverage with ingredient |
| 20130273199 | Beverage and method for producing a sparkling beverage which is a nutritious alternative to |
| | milk with all the nutrition of milk plus antrhocyanins |
| 20130202742 | High-potency sweetener composition with vitamin and compositions sweetened therewith |
| 20110244076 | Carbonated dairy nutrient beverage and method of making a carbonated dairy nutrient beverage |
| | to supply the same nutrition of skim milk in the human diet |
| 20090074919 | American school lunch meals |
| 20070281059 | Carbonated beverage national school lunch meal |
| 20070116838 | High-potency sweetener composition with antioxidant and compositions sweetened therewith |
| 20070116835 | High-potency sweetener composition with vitamin and compositions sweetened therewith |
| 20040096547 | Healthy alternative ready-to-drink energy beverage |
| 20030113408 | Carbonated fortified milk-based beverage and method or suppressing bacterial growth in the |
| | beverage |
| 20150189907 | Method for producing beverages by acid removal |
| 20140271593 | Formulations of water-soluble derivatives of vitamin e and compositions containing same |
| 20130202742 | High-potency sweetener composition with vitamin and compositions sweetened therewith |
| 20070281059 | Carbonated beverage national school lunch meal |
| 20070116835 | high-potency sweetener composition with vitamin and compositions sweetened therewith |
| 20130273199 | Beverage and method for producing a sparkling beverage which is a nutritious alternative to |
| | milk with all the nutrition of milk plus antrhocyanins |
| 20120189747 | Method and apparatus for making beverages |
| 20100015315 | Edible film-shaped preparation with cola taste |
| 20080193596 | Low-glycemic mixtures |
| 20070178193 | Mineral-fortified beverage composition |
| 20070141203 | Beverages containing water-soluble vitamin E |
| 20070054026 | Method and apparatus for making beverages |
| 20040219274 | Beverages containing water-soluble vitamin E |
| 20040096547 | Healthy alternative ready-to-drink energy beverage |
| 20020102331 | Calcium-supplemented beverages and method of making same |
| 20080038408 | Packaged beverages |
| 20140255585 | Beverage |
| 20100316770 | Beverage packed in container |
| 20100015288 | Packed drink |
| 20090196955 | Shelf-stable beverage composition |
| 20070212468 | Methods and apparatuses for making compositions comprising an acid and an acid degradable |
| | component and/or compositions comprising a plurality of selectable components |

The above prior art review (both scientific literature and patent documents) confirms that the new and useful composition, method of preparation and applications of the present invention, Nutritionally Premium Colas (NPC), have not been obvious to a person having ordinary skill in the art of cola carbonated soft drinks.

The new and useful idea of using vitamin C (ascorbic acid) as a nutritive and health promoting organic acid in formulating cola carbonated soft drinks is the heart of the present invention.

In view of above, it is scientifically, socially and ethically important to produce and offer safe, easy-to-use, economic and nutritionally desirable NPC carbonated soft drinks to consumers globally.

### BRIEF SUMMARY OF THE INVENTION

Disclosed are the use of nutritive and health promoting vitamin C (ascorbic acid) in formulation, preparation and applications of Nutritionally Premium Cola (NPC) carbonated soft drinks. Also disclosed are exemplary compositions, methods of preparation and applications of NPC carbonated soft drinks.

### DETAILED DESCRIPTION OF THE INVENTION

Historical Perspective: since John Pemberton invented Coca-Cola in 1886 and Caleb Bradham created Pepsi-Cola in 1898, the cola flavor has been the signature flavor among carbonated soft drinks. While the cola flavor is enormously popular, consumers always demanded healthier cola carbonated soft drinks. Gradual and incremental improvements have naturally occurred over the time. However, the first breakthrough in formulation of cola carbonated soft drinks occurred when so-called “diet” versions of colas were introduced to the market in 1960s in response to consumer demand and government concern over obesity and diabetes type 2. These diet colas initially used no-calorie artificial high-intensity sweeteners (e.g., saccharin, aspartame, acesulfame potassium and sucralose). Consumers demanded healthier sweeteners and, as a result, colas using no-calorie natural high-intensity sweeteners (e.g., stevia leaf extract and monk fruit extract) were introduced to market within the last decade. The present invention is the second breakthrough in formulation of cola carbonated soft drinks in response to consumer demand for healthier colas. This invention brings a paradigm shift in the nutritional value, and image of carbonated soft drinks from negative to positive.

The present invention represents a new composition, method of preparation and applications, above and beyond the prior art, of producing Nutritionally Premium Cola (NPC) using the nutritive and health promoting vitamin C (ascorbic acid) as the organic acid of choice in the formulation. The present invention meets four basic criteria for its purpose (safety, ease-of-use, economic, and nutritionally desirable) and therefore is useful:
1) Safety: this method avoids phosphoric acid with numerous health risks including risks to bones, kidney and teeth. Instead, it uses vitamin C (ascorbic acid) which is considered Generally Recognized As Safe (GRAS). Safety of use of vitamin C during the past several decades have been proven beyond any shadow of doubt.
2) Ease-of-Use: vitamin C (and its salts such as sodium ascorbate, potassium ascorbate, calcium ascorbate) is currently used as dietary supplement. Vitamin C (natural and synthetic) is among the most widely taken dietary supplements and is available in a variety of forms, including tablets, drink mix packets, capsules, and as crystalline powder. This shows that there is a great ease-of-use for vitamin C. In fact, using vitamin C as an acid in cola carbonated soft drinks was found to be very easy when prototypes of NPC were developed.
3) Economic: vitamin C is relatively inexpensive due to its mass production. For example, the average wholesale price of vitamin C is about $10.00/kg. This means that 90 mg (100% RDA) of vitamin C would cost about $0.001. This shows use of vitamin C is economic. This cost could be even lower for global syrup manufacturers. Also, assuming NPC will be sold at a premium price, vitamin C cost would be truly negligible.
4) Nutritionally Desirable: vitamin C is more than nutritionally desirable! It is an “essential” nutrient. We must receive it from food or supplements to avoid health problems. That is the reason it is in the World Health Organization (WHO) list of essential medicines. The recommendation of Linus Pauling Institute (world's leading scientific entity on vitamin C) shows the status of vitamin C in our daily nutrition: “Because of the very high benefit-to-risk ratio of vitamin C supplementation, and to ensure tissue and body saturation of vitamin C in almost all healthy people, the Linus Pauling Institute recommends a vitamin C intake of at least 400 mg daily for adult men and women . . . . To make sure you meet the Institute's recommendation, supplemental vitamin C in two separate 250-mg doses taken in the morning and evening is recommended.” This is 5.5 times of RDA for vitamin C. Fortunately, the tolerable upper intake level (maximum daily intake unlikely to cause adverse health effects) of vitamin C is 2,000 mg/day for adults (male and female).

As far as acidity of carbonated soft drinks is concerned, we may consider the following values: high acid (pH<4.0), medium acid (pH 4.0-5.0), low acid (pH 5.0-7.0).

Since pH of carbonated water (without any other ingredient) is about 3.8 to 4.0. carbonated water is considered a high/medium acid drink. If preferred, acidity of NPC carbonated soft drink can be easily adjusted to desirable level by addition of sodium carbonate or potassium carbonate or combination thereof.

NPCs should be prepared in processing plants that meet FDA's Current Good Manufacturing Practices (cGMPs). Furthermore, the FDA Food Safety Modernization Act (FSMA) aim is to ensure the U.S. food supply is safe by shifting the focus of federal regulators from responding to contamination to preventing it. FSMA includes soft drinks in its regulated products. Processors are required to have Hazard Analysis and Critical Control Points (HACCP) plan or Hazard Analysis and Risk-based Preventive Controls (HARPC) plan in place. While facilities vary, in general, filtration is recommended at the following stages of beverage processing (Donaldson Filtration Solutions www.donaldson.com):
1) Incoming source water: Pre-filtration of municipal or spring water to remove sediment, particulates and larger microorganisms through a 25 micron filter; produces industrial water suitable for equipment and container cleaning.
2) Intermediate processing: Depth filtration through a 10 micron filter to remove smaller particulates and impurities shed during resin or carbon activation steps; specially to preserve integrity of reverse osmosis (RO) membranes.
3) Initial bacterial reduction: Sterile-grade filtration through a 5 micron to 1 micron filter to remove majority of microorganisms potentially present in the water or in containers.
4) Final sterile filtration: Critical filtering through a 0.2 micron filter just prior to packaging; using a sterile-grade membrane filter to capture last surviving microorganisms.
5) In storage: Tank vent filters on stored product in holding tanks; to prevent the ingression of airborne contaminants while equalizing tank pressure as volume changes.

Depending on their applications in market, Nutritionally Premium Colas may be divided into four categories:

Category 1) Healthy Refreshment NPCs (original cola flavor)
Category 2) Healthy Refreshment NPCs (with complementary and new flavors)

### Category 3) Functional NPCs

### Category 4) Health Promoting and Risk Reducing NPCs

In the most preferred embodiment, the present invention relates to composition, method of preparation and applications of Nutritionally Premium Colas (NPCs) made with vitamin C (ascorbic acid).

We target to have from 10% RDA (90 mg×0.1=9 mg or “good source”) up to 1000% RDA (90 mg×10=900 mg) vitamin C in 240 ml of NPC at the end of the shelf life. The amount of vitamin C in NPC that reaches the hands of consumer depends on several factors including other ingredients in NPC, pH of NPC, processing temperature and time, residual oxygen in headspace, oxygen and light barrier properties of package, distribution temperature and time, and targeted shelf life of 3 to 6 months. To minimize loss of vitamin C, the following precautions should be taken to the extent possible:

a) Preparation of syrup (or premix powder) is done at a refrigerated temperature
b) Using filtered water, carbonation is done at refrigerated temperature.
c) NPC is optionally filtered through a 0.65 micron to 0.2 micron filter at refrigerated temperature.
d) Packaging of NPC is done at refrigerated temperature. Any washing of packages should be done with cold water.
e) Distribution and storage of NPC are optionally done at refrigerated temperature.

Despite all the above efforts, for any specific NPC product we need to include a reasonable overage to guarantee presence of the desirable amount of vitamin C in NPC at the end of the shelf life. If the amount of vitamin C causes too much tartness (sourness) and low pH, proper amount of sodium bicarbonate (or potassium bicarbonate or their combination) can be added to the formulation at the start of syrup preparation. This will convert ascorbic acid to sodium or potassium ascorbate and correct both undesirable tartness and low pH. In other words, vitamin C becomes buffered vitamin C. If no loss of vitamin C in solution, and therefore no need for overage, is desirable, the premix powder should be placed in a dispensing cap, where the premix powder is mechanically introduced into the carbonated water at the time of consumption.

In specific embodiments, the Nutritionally Premium Colas contains vitamin C in form of natural or synthetic ascorbic acid, sodium ascorbate, potassium ascorbate, calcium ascorbate, magnesium ascorbate, dehydroascorbate, ascorbyl palmitate, or combination thereof.

In another specific embodiment, natural liquid or solid cola flavor can be used. If needed, complementary and new natural flavors (such as cherry, vanilla, lemon/lime, orange, mango, root beer, coffee, peach, mint, cinnamon, almond, kiwi-strawberry, berry mix, apple, raspberry, watermelon, pomegranate, grapes, cranberry, banana, cardamom, mandarin, caramel, cucumber, cantaloupe, pineapple, tropical, ginger and chocolate) can also be added to natural cola flavor.

In another specific embodiment, no-calorie, natural high-intensity sweeteners (e.g., stevia leaf extract and monk fruit extract), calorific natural sweeteners (e.g., sugar and high-fructose corn syrup), and their combination may be used as sweetener.

In further specific embodiments, no-calorie, artificial high-intensity sweeteners (e.g., saccharin, aspartame, acesulfame potassium and sucralose) or their combination can be used as sweetener.

In further specific embodiments, optional ingredients such as caramel color, caffeine, Acacia gum (gum Arabic), potassium sorbate or their combination are included in the formulation of syrup or premix powder.

In further specific embodiments, complementary and auxiliary organic acids such as citric acid, tartaric acid, malic acid, lactic acid or their combination are included in the formulation of syrup or premix powder.

In further specific embodiments, complementary and auxiliary sodium, potassium or calcium salt of organic acids (citric acid, tartaric acid, malic acid, lactic acid) or combination thereof are included in the formulation of syrup or premix powder.

In further specific embodiments, other essential nutrients such as vitamins, minerals, proteins, peptides, amino acids, unsaturated fatty acids and lipids, soluble fibers, probiotics or their combination are included in the formulation of syrup or premix powder.

In further specific embodiments, functional ingredients are included in the Nutritionally Premium Cola for the following applications: energy, sport, relaxation, antioxidant, probiotic and prebiotic.

In further specific embodiments, extract, concentrate or isolate from fruit, root, seed, flower, leaf or bark of a plant selected from the group comprising turmeric, ginger, milk thistle, cranberry, saw palmetto, cinnamon, rhodiola, lemon balm, St. john's wort, Panax ginseng, American ginseng, echinacea, horny goat weed, soy, black cohosh, Coleus forskohlii, Ginkgo biloba, rosemary, holy basil, elderberry, ashwagandha, olive leaf, dandelion, maca, boswellia serrata, rose hips, grapeseed, grape skin, kava, licorice, green coffee, green tea, sweet orange peel, prickly pear, devils claw, nettle, hibiscus, feverfew or combination thereof is added for health promotion/risk reduction (healthy aging, weight management, blood sugar health, heart health (cholesterol and bp reduction), joint health, immunity health, memory health and bone health).

In further specific embodiments, Nutritionally Premium Cola (NPC) is prepared in a processing plant with HACCP plan or HARPC plan in place with a method comprising the following steps:
A. Mixing vitamin C (ascorbic acid), natural cola flavor and natural sweetener to form a uniform, smooth syrup or premix powder. Minimal water can also be added, if needed.
B. If preferred, optional ingredients such as sodium bicarbonate, caramel color, caffeine, potassium sorbate, functional ingredients are also added to the mixture.
C. The resultant uniform, smooth syrup or premix powder is mixed with pre-filtered carbonated water (or with water to be carbonated later), at a predetermined ratio.
D. If needed, the resultant NPC is optionally filtered through a 0.65 micron to 0.2 micron filter just prior to packaging.
E. NPC is packaged.
F. Packaged NPC is distributed preferably at refrigerated temperature. It will be stored and preferably offered in the refrigerated section of supermarkets.

In further specific embodiments, mixing vitamin C (ascorbic acid), natural dry cola flavor and natural sweetener to form a uniform, smooth premix powder is placed in a dispensing cap.

In further specific embodiments, Nutritionally Premium Cola is a safe, easy-to-use, economic and nutritionally desirable carbonated soft drink.

In further specific embodiments, the uniform, smooth premix can be packaged as effervescent tablet or effervescent powder.

Accordingly, it is the principal objective of the present invention to use nutritive and health promoting vitamin C (ascorbic acid) to formulate and produce Nutritionally Primum Cola (NPC). The present invention fulfills the aforesaid objective and provides further related advantages.

The following examples are included herein as exemplary embodiments of the present invention.

### Example 1 (NPC—No Calorie, Cola Flavor)

In a clean wide-mouth mixer, 1.5 grams vitamin C and water were mixed to almost a clear solution. Then, pre-weighed sodium bicarbonate was slowly added until all foam was generated and dissipated resulting in a clear solution without any foam. This optional step is to adjust the final pH of the cola to be less acidic. As the next step, pre-weighed monk fruit extract and natural liquid cola flavor were added to the mixture. Then, caramel color and caffeine were added to the above solution and gently mixed until a uniform, smooth black syrup was obtained which was immediately refrigerated. The yield was 10 grams syrup. As the next step, 10 grams syrup was added to 1 liter (1,000 grams) commercially available carbonated water and mixed (mixing ratio; 1 syrup:100 carbonated water) to obtain the NPC—No Calorie, Cola Flavor. In this example, ingredients except vitamin C, natural cola flavor and natural sweetener are “optionally” included in the formulation. As this prototype was prepared for immediate consumption, filtration was not carried out. Taste test was conducted by 2 experienced food science and nutrition experts with good results. pH of NPC was found to be 4.4. Nutrition Facts table and list of ingredients were subsequently prepared.

### Example 2 (NPC—No Calorie, Cherry Cola Flavor)

In a clean wide-mouth mixer, 1.5 grams vitamin C and water were mixed to almost a clear solution. Then, pre-weighed sodium bicarbonate was slowly added until all foam was generated and dissipated resulting in a clear solution without any foam. This optional step is to adjust the final pH of the cola to be less acidic. As the next step, pre-weighed stevia leaf extract and natural liquid cola flavor and natural liquid cherry flavor were added to the mixture. Then, caramel color and caffeine were added to the above solution and gently mixed until a uniform, smooth black syrup was obtained which was immediately refrigerated. The yield was 10 grams syrup. As the next step, 10 grams syrup was added to 1 liter (1,000 grams) commercially available carbonated water and mixed (mixing ratio; 1 syrup:100 carbonated water) to obtain the NPC—No Calorie, Cherry Cola Flavor. In this example, ingredients except vitamin C, natural liquid cola and cherry flavors and natural sweetener are “optionally” included in the formulation. As this prototype was prepared for immediate consumption, filtration was not carried out. Taste test was conducted by 2 experienced food science and nutrition experts with good results. pH of NPC was found to be 4.4. Nutrition Facts table and list of ingredients were subsequently prepared.

### Example 3 (NPC—No Calorie, Cola Flavor—Caffeine Free)

In a clean wide-mouth mixer, 1.5 grams vitamin C and water were mixed to almost a clear solution. Then, pre-weighed sodium bicarbonate was slowly added until all foam was generated and dissipated resulting in a clear solution without any foam. This optional step is to adjust the final pH of the cola to be less acidic. As the next step, pre-weighed monk fruit extract, stevia leaf extract and natural liquid cola flavor were added to the mixture. Then, caramel color was added to the above solution and gently mixed until a uniform, smooth black syrup was obtained which was immediately refrigerated. The yield was 10 grams syrup. As the next step, 10 grams syrup was added to 1 liter (1,000 grams) commercially available carbonated water and mixed (mixing ratio; 1 syrup:100 carbonated water) to obtain the NPC—No Calorie Cola Flavor—Caffeine Free. In this example, ingredients except vitamin C, natural cola flavor and natural sweetener are “optionally” included in the syrup. As this prototype was prepared for immediate consumption, filtration was not carried out. Taste test was conducted by 2 experienced food science and nutrition experts with good results. pH of NPC was found to be 4.4. Nutrition Facts table and list of ingredients were subsequently prepared.

### Example 4 (NPC—Low Calorie, Cola Flavor)

In a clean wide-mouth mixer, add pre-weighed sugar, 1.5 grams vitamin C, caramel color, acacia gum (gum Arabic), sodium bicarbonate (optional to adjust the final pH of the cola to be less acidic), natural dry cola flavor, stevia leaf extract and caffeine. Then, gently mix to a uniform, smooth beige powder. The yield was 45 grams premix. As the next step, 45 grams premix was added to 1 liter (1,000 grams) commercially available carbonated water and mixed (mixing ratio; 4.5 premix:100 carbonated water) to obtain the NPC—Low Calorie, Cola Flavor. In this example, ingredients except vitamin C, natural cola flavor and natural sweetener are “optionally” included in the premix or syrup. As this prototype was prepared for immediate consumption, filtration was not carried out. Taste test was conducted by 2 experienced food science and nutrition experts with good results. pH of the NPC was found to be 4.3. Nutrition Facts table and list of ingredients were subsequently prepared.

Alternatively, pure water can be added to the premix to obtain 100 grams syrup and then add this syrup to carbonated water (mixing ratio; 10 syrup:100 carbonated water). It should be noted that premixes could be easily shipped without or with added sugar to bottlers who can add pre-weighed sugar (if not previously added) and water to convert premix into syrup. Premixes can also be directly used in new generation of fountain beverage dispenser where fountain dilutes a pre-determined quantity of premix (also called “post-mix” or “beverage base”) with carbonated water when dispensed.

### Example 5 (NPC—No Calorie, Curcumin—Cola Flavor)

In a clean wide-mouth mixer, 1.5 grams vitamin C and pre-weighed dry natural cola flavor, monk fruit extract, sodium bicarbonate (optional step is to adjust the final pH of the cola to be less acidic), gum acacia (gum Arabic), curcumin, stevia leaf extract and caramel color were mixed until a uniform yellowish powder was obtained. The yield was 3.5 grams. As the next step, 3.5 grams powder was added to 1 liter (1,000 grams) commercially available carbonated water and mixed (mixing ratio; 0.35 powder:100 carbonated water) to obtain the NPC—No Calorie Curcumin Cola Flavor. In this example, ingredients except vitamin C, natural cola flavor natural sweetener and curcumin are “optionally” included in the powder. As this prototype was prepared for immediate consumption, filtration was not carried out. Taste test was conducted by 2 experienced food science and nutrition experts with good results. pH of the NPC was found to be 4.3. Nutrition Facts table and list of ingredients were subsequently prepared.

Although this invention has certain preferred embodiments, it will be obvious to those skilled in the art that various changes and modifications may be made therein without departing from the invention, and all such changes and modifications are intended to fall within the true spirit and scope of the invention.

1. A composition of Nutritionally Premium Cola (NPC) free from phosphoric acid, consisting of carbonated water, vitamin C (ascorbic acid), natural cola flavor and natural sweetener.

2. The composition according to claim 1, wherein concentration of vitamin C is between 9 mg to 900 mg per 240 ml of NPC at the end of shelf life.

3. The composition according to claim 1, wherein natural or synthetic vitamin C in form of sodium ascorbate, potassium ascorbate, calcium ascorbate, magnesium ascorbate, zinc ascorbate, dehydroascorbate, ascorbyl palmitate, or combinations thereof.

4. The composition according to claim 1, wherein Nutritionally Premium Cola also contains complementary and new natural flavors such as cherry, vanilla, lemon/lime, orange, mango, root beer, coffee, peach, mint, cinnamon, almond, kiwi-strawberry, berry mix, apple, raspberry, watermelon, pomegranate, grapes, cranberry, banana, cardamom, mandarin, caramel, cucumber, cantaloupe, pineapple, tropical, ginger and chocolate.

5. The composition according to claim 1, wherein natural sweetener is no-calorie high intensity monk fruit extract, no-calorie high intensity stevia leaf extract, sugar, high fructose corn syrup, or combinations thereof.

6. The composition according to claim 1, wherein synthetic high intensity sweeteners such as saccharin, aspartame, acesulfame potassium and sucralose or their combinations are included in the formulation.

7. The composition according to claim 1, wherein Nutritionally Premium Cola contains caramel color.

8. The composition according to claim 1, wherein Nutritionally Premium Cola contains caffeine.

9. The composition according to claim 1, wherein Nutritionally Premium Cola contains soluble bicarbonates such as sodium bicarbonate, potassium bicarbonate or combinations thereof.

10. The composition according to claim 1, wherein Nutritionally Premium Cola contains Acacia gum (gum Arabic).

11. The composition according to claim 1, wherein Nutritionally Premium Cola contains potassium sorbate as preservative.

12. The composition according to claim 1, wherein Nutritionally Premium Cola contains complementary and auxiliary organic acids (such as citric acid, tartaric acid, malic acid, lactic acid), their sodium, potassium or calcium salts or combinations thereof.

13. The composition according to claim 1, wherein Nutritionally Premium Cola contains other “essential nutrients” such as vitamins, minerals, proteins, peptides, amino acids, unsaturated fatty acids and lipids, soluble fibers, probiotics or combinations thereof.

14. The composition according to claim 1, wherein Nutritionally Premium Cola contains health promoting and risk reducing extract, concentrate or isolate from fruit, root, seed, flower, leaf or bark of a plant selected from the group comprising turmeric, ginger, milk thistle, cranberry, saw palmetto, cinnamon, rhodiola, lemon balm, St. john's wort, Panax ginseng, American ginseng, echinacea, horny goat weed, soy, black cohosh, Coleus forskohlii, Ginkgo biloba, rosemary, holy basil, elderberry, ashwagandha, olive leaf, dandelion, maca, boswellia serrata, rose hips, grapeseed, grape skin, kava, licorice, green coffee, green tea, sweet orange peel, prickly pear, devils claw, nettle, hibiscus, feverfew or combination thereof.

15. The composition according to claim 1, wherein the resultant NPC is a safe, easy-to-use, economic and nutritionally desirable carbonated soft drink.

16. A method of preparing Nutritionally Premium Cola, said method comprising the steps of:
A. Mixing vitamin C (ascorbic acid), natural cola flavor and natural sweetener to form a uniform, smooth syrup or premix powder.
B. If preferred, optional ingredients such as sodium bicarbonate, caramel color, caffeine, potassium sorbate, functional ingredients, health promoting and risk reducing ingredients are also added to the mixture.
C. The resultant uniform, smooth syrup or premix powder is mixed with filtered carbonated water (or with filtered water to be carbonated later) at a predetermined ratio to obtain NPC.
D. NPC is optionally filtered through a 0.65 micron to 0.2 micron filter just prior to packaging.
E. NPC is packaged.
F. Packaged NPC is distributed preferably at refrigerated temperature.

17. The method according to claim 16, wherein the uniform, smooth dry premix powder is placed in a dispensing cap.

18. Application of Nutritionally Premium Cola wherein it is used as a healthy refreshment beverage.

19. Application of Nutritionally Premium Cola according to claim 18 wherein it is used for health promotion/risk reduction applications such as healthy aging, weight management, blood sugar health, heart health (cholesterol and blood pressure reduction), joint health, immunity health, memory health and bone health.

20. Application of Nutritionally Premium Cola according to claim 18 wherein it is used for energy, sport, relaxation, antioxidant, and probiotic and prebiotic.
